(19) United States
(12) Patent Application Publication
(10) Pub. No.: US 2024/0194431 A1
(43) Pub. Date: Jun. 13, 2024

(54) CONTROL MODULE FOR AN ELECTRONIC DEVICE ADAPTED TO WITHSTAND SHOCKS

(71) Applicant: ETA SA MANUFACTURE HORLOGERE SUISSE, Grenchen (CH)

(72) Inventors: Raphaël BALMER, Vicques (CH); Daniel PARASCHIVESCU, Grenchen (CH)

(73) Assignee: ETA SA MANUFACTURE HORLOGERE SUISSE, Grenchen (CH)

(21) Appl. No.: 18/503,484

(22) Filed: Nov. 7, 2023

(30) Foreign Application Priority Data
Dec. 9, 2022 (EP) 22212590.8

(51) Int. Cl. H01H 71/12; G04B 3/04; H01H 13/14

(52) U.S. Cl. CPC H01H 71/128; G04B 3/048; H01H 13/14

(57) ABSTRACT

A control module (10) for an electronic device including a push-button (11) including a striker element (111), a switch (12) adapted to occupy a connected state and a rest state, said striker element (111) being configured to drive the switch (12) into one or the other of the connected and rest states, the control module further comprising a stop member (13) against which the striker element (111) comes to bear when it drives the switch (12) into the connected state or into the rest state.

### CROSS REFERENCE TO RELATED PATENT APPLICATIONS

This application is claims priority to European Patent Application No. 22212590.8, filed on Dec. 9, 2022, the disclosures of which are incorporated by reference herein their entireties.

### Technical Field of the Invention

The invention relates to the field of electronic devices, and in particular to members for controlling the functions of an electronic device.

More particularly, the invention relates to a control module for an electronic device adapted to withstand shocks.

Advantageously, the present invention is particularly suited to portable electronic devices, for example electronic watches.

### Technological Background

The control members of electronic devices generally consist of switches adapted to authorise or prohibit the passage of a current, enabling, for example, a command to be transmitted in order to perform a function.

In particular, in order to authorise or prohibit the passage of a current, switches are intended to occupy a rest position and a connecting position in at least one whereof they are driven by the action of a user.

In particular, switches are known to comprise a flexible membrane covering a resilient blade adapted to connect connection terminals to each other when it is operated by a user, i.e. when it is stressed, and to prevent any connection between the terminals when it is at rest.

Electronic devices often feature a push-button adapted to be handled by the user so as to come into contact with the flexible membrane of the switch, via a striker, in order to deform the resilient blade into its connecting position.

When the electronic device is subjected to a shock on the push-button, the resilient blade may be plastically deformed by the forces applied thereto, and consequently could suffer irreversible damage.

One solution to this problem is to increase the size of the contact surface of the striker so that it distributes the transmitted forces as evenly as possible, thereby reducing the pressure to which the resilient blade is subjected.

However, this solution may not be feasible for applications where dimensions are a critical design constraint, for example in microelectronic or micromechanical fields, such as the horological field.

Furthermore, this solution may not be feasible, for example due to manufacturing constraints.

Another solution consists of giving the flexible film an excessive thickness. Given that this film is typically made of silicone, this excessive thickness is intended to deform elastically in the event of a shock to absorb the forces.

However, such an excessive thickness is not suitable for absorbing high forces, such as those generated by a shock corresponding to a deceleration of 5000G, as specified in standard NIHS 91-30. This is because the flexible film deforms so much under the effect of the forces received and transmits them to the resilient blade and to the terminal, which deform plastically.

### SUMMARY OF THE INVENTION

In order to overcome the aforementioned drawbacks, the present invention relates to a control module for an electronic device comprising:
a push-button comprising a striker element;
a switch adapted to occupy a connected state and a rest state, said striker element being configured to drive the switch in one or the other of the connected and rest states when the push-button is operated;
a stop member against which the striker element comes to bear when it drives the switch in the connected state or in the rest state.

It should be noted that, in the present invention, the stop member is separate from the switch. The switch can therefore advantageously be a standard, commercially-available component.

Advantageously, the stop member allows the progression of the moving push-button to be blocked in the event of excessive force being applied to the switch. The intensity of the maximum force applied to the switch is thus controlled and the switch is protected against excessive forces, such as those caused by shocks.

In specific embodiments, the invention can further include one or more of the following features, which must be considered singly or according to any combination technically possible.

In particular embodiments, the striker element is provided with an axial protrusion extending from a bearing surface, with which it forms a shoulder. The striker element is configured so that, when it drives the switch in the connected state or in the rest state, the axial protrusion applies pressure to the switch and the bearing surface rests in abutment against the stop member.

In particular embodiments, the stop member takes the form of a wall attached to the switch and comprises a through-hole intended to receive the axial protrusion of the push-button when the striker element drives the switch into the connected state or into the rest state. In other words, the axial protrusion of the push-button is intended to engage through the hole in order to drive the switch into the connected state or into the rest state.

In particular embodiments, the switch comprises a frame, the stop member having a concavity arranged facing the switch so that it bears on said frame via a peripheral zone extending at the periphery of the stop member.

In particular embodiments, the control module comprises a damper configured to absorb part of the forces at play by deforming when the striker element drives the switch into the connected state or into the rest state, at least when said forces are greater than a predetermined threshold.

In particular embodiments, the damper is arranged on the bearing surface so as to be compressed when the striker element drives the switch into the connected state or into the rest state.

In particular embodiments, the damper takes the form of a washer made of an elastically deformable material arranged around the axial protrusion.

In particular embodiments, the damper is intended to be arranged between a structure of the horological movement and the switch, in the continuation of the direction of travel of the push-button.

In particular embodiments, the switch comprises a frame to which a resilient blade and connection terminals are attached. The resilient blade is moved into a connecting position wherein it generates contact between the connection terminals, when the switch is in the connected state, and is moved into a rest state wherein it prevents contact between the connection terminals, when the switch is in the rest state. The stop member is arranged in the continuation of the direction of travel of the push-button against one of the connection terminals so that the latter is inserted between the stop member and the striker element.

In particular embodiments, the push-button comprises a push-button head to which is connected a push-button rod slidably engaged in a guide tube and comprising a free end to which the striker element is attached. The push-button comprises a spring inserted between the push-button head and the guide tube so as to force said push-button to move towards its rest position.

In particular embodiments, the striker element comprises a body of substantially cylindrical shape having a radial dimension extending in a direction orthogonal to the direction of movement of the push-button, said radial dimension being smaller than the outside diameter of an end of the guide tube at which it is arranged.

According to another aspect, the present invention relates to a watch comprising a case in which an electronic horological movement is housed. The latter comprises a control module as described above, the push-button being engaged through a middle with which the case is equipped, the switch and the stop member being attached to a structure of the horological movement.

### BRIEF DESCRIPTION OF THE FIGURES

Other features and advantages of the invention will become apparent upon reading the following detailed description given by way of a non-limiting example, and with reference to the accompanying drawings, in which:

FIG. 1 diagrammatically shows a sectional view of a middle of a watch housing an electronic horological movement comprising a control module according to a preferred example embodiment of the invention, and a detail view of a switch of the control module;

FIG. 2 shows a sectional view of a middle of a watch housing an electronic horological movement comprising a control module according to another example embodiment of the invention.

It should be noted that the figures are not necessarily drawn to scale for clarity purposes.

### DETAILED DESCRIPTION OF THE INVENTION

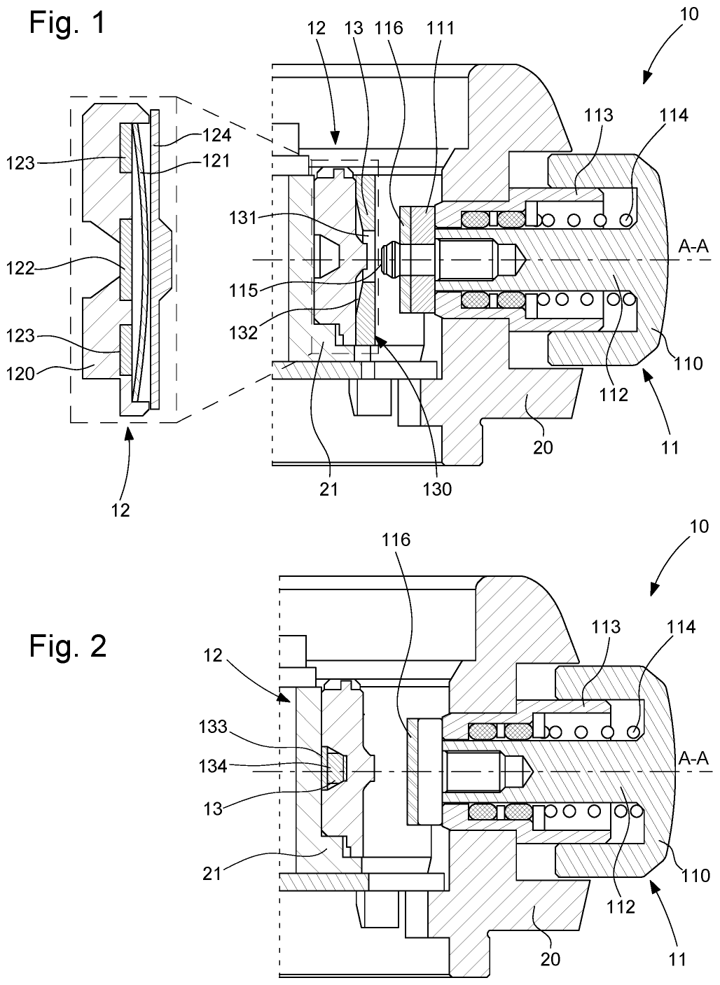

In the example embodiments of the invention shown in FIGS. 1 and 2 and described in the present text, the invention is applied to the horological field. In particular, the invention relates to a control module 10, here arranged in an electronic horological movement housed in a case of a watch, equipped with a middle 20, and intended to control a function on request, for example, from a user.

As can be seen from FIGS. 1 and 2, the control module 10 comprises a push-button 11 which can be moved in translation in direction A-A, and which is intended to be operated by the user. In the particular examples shown in the figures, the push-button 11 is engaged through the middle 20 so as to be accessible to the user. Alternatively, the push-button may be rotatable or, more generally, may undergo any type of motion.

The control module 10 also includes a switch 12 intended to be actuated by a user when the push-button 11 is operated, and a stop member 13 against which the push-button 11 is intended to rest, i.e. come to bear, when the switch 12 is actuated.

In particular, the switch 12 is adapted to occupy a connected state and a rest state, the push-button 11 being configured such that, when it actuates said switch 12, it drives it into one or the other of these states.

As shown diagrammatically in the detail view of FIG. 1, in one example embodiment of the invention, the switch 12 may comprise a frame 120 to which a resilient blade 121 made of an electrically conductive material and connection terminals 122 and 123 are attached. As can be seen in the detail view of FIG. 1, the switch 12 may comprise a connection terminal called a “central terminal” 122 arranged in the direction of travel of the push-button 11, i.e. in alignment with direction A-A, and one or more peripheral terminals 123. Preferably, the resilient blade 121 is configured to occupy, when the push-button 11 is operated by the user, a connecting position wherein it generates a contact between the central terminal 122 and the one or more peripheral terminals 123. When operated and driving the resilient blade 121 into the connecting position, the push-button 11 is configured to rest in abutment against the stop member 13.

In particular, when the user operates the push-button 11, the latter applies pressure to the resilient blade 121, so as to deform it into an unstable, flat position wherein it is in contact with the central terminal 122 and the peripheral terminals 123. The resilient blade 121 is also configured to occupy, when the push-button 11 is not operated by the user, a stable rest position wherein it prevents any contact between the central terminal 122 and the peripheral terminals 123. As can be seen from the detail view in FIG. 1, when in this position, the resilient blade 121 can be bent so as to be pre-stressed to exhibit resilient characteristics.

The switch 12 may also include a flexible membrane 124 covering the resilient blade 121, on which the push-button 11 is intended to bear when operated. However, this flexible membrane 124 is not essential to the invention.

In the preferred example embodiment of the invention shown in FIG. 1, the push-button 11 rests directly in abutment against the stop member 13, as described in greater detail below. In another example embodiment shown in FIG. 2, the push-button 11 rests indirectly against the stop member 13, with the switch 12 inserted between said push-button 11 and said stop member 13.

As can be seen from FIGS. 1 and 2, the switch 12 and the stop member 13 are intended to be attached to a structure 21 of the horological movement, for example by any means known to a person skilled in the art.

The push-button 11 comprises a push-button head 110 extending outside the middle 20 and intended to be handled by the user. The push-button 11 also comprises a striker element 111 connected to the push-button head 110 by means of a push-button rod 112 slidably engaged in a guide tube 113 attached in a through-hole in the middle 20. For example, the striker element 111 is screwed into the push-button rod 112, or is attached by any suitable means within the reach of a person skilled in the art.

The guide tube 113 comprises, at a first end, a first portion by which it is engaged in the through-hole in the middle 20, and comprises, at a second end, a second portion having a larger external diameter than that of the first portion so as to form a shoulder therewith. As shown in FIG. 1, the guide tube 113 rests in abutment against the middle 20 via this shoulder. The push-button 11 comprises a compression spring 114 inserted between the push-button head 110 and the shoulder of the guide tube 113, so as to force the push-button 11 to move into a rest position.

As shown in FIG. 1, the striker element 111 rests against the first end of the guide tube 113 when the push-button 11 is in its rest position. In other words, when resting against the stop member 13 and against the guide tube 113, the striker element 111 defines travel limit stops for the push-button 11.

The striker element 111 comprises a body of substantially cylindrical shape with a radial dimension extending in a direction orthogonal to the direction A-A, said radial dimension advantageously being smaller than the outside diameter of the first portion of the guide tube 113. This feature facilitates the assembly of the striker element 111 on the push-button rod 112, insofar as it can be carried out before the push-button 11 is attached to the watch middle 20, i.e. before it engages in the through-hole in said middle 20.

In the preferred example embodiment shown in FIG. 1, the body of the striker element 111 is provided with an axial protrusion 115 extending from a bearing surface, with which it forms a shoulder. The striker element 111 is configured so as to apply, via the axial protrusion 115, pressure on the resilient blade 121, when the push-button 11 is operated by the user, in order to cause it to deform until it occupies the connecting position and until the bearing surface rests in abutment against the stop member 13.

To summarise, the invention prevents excessive stresses from being applied to the switch 12, insofar as the stop member 13 acts as a translational stop for the push-button 11 and transfers the forces received to the frame or optionally to the structure 21 of the horological movement. The invention thus also makes it possible to control the intensity of the maximum force applicable to the switch 12, which is defined in particular by the length of the axial protrusion 115.

Advantageously, the control module 10 can include a damper 116 configured to absorb part of the forces at play, by deforming, at least when said forces are greater than a predetermined threshold, when the push-button 11 actuates the switch 12. Preferably, it is made of an elastically deformable material, such as elastomer, or has an elastically deformable structure, such as a compression spring.

In one embodiment of the invention, the damper 116 is arranged on the bearing surface so as to be compressed when the resilient blade 121 is driven into the connecting position as seen in FIGS. 1 and 2. In particular, in the preferred example embodiment shown in FIG. 1, the damper 116 is in the form of a washer arranged around the axial protrusion 115.

In a further embodiment of the invention not shown in the figures, the damper 116 can be arranged between the structure 21 of the horological movement and the switch 12, in the continuation of the A-A direction. In this way, if the switch 12 were subjected to excessive forces, it would be able to transmit part of these forces by slightly moving or deforming locally in the damper 116, which would absorb the part of the forces transmitted by the switch 12.

In the example embodiment shown in FIG. 1, the stop member 13 takes the form of a wall provided with a stop surface 130, through which a through-hole 131 extends. When the push-button 11 is operated, the bearing surface of the striker element 111 is intended to rest in abutment against the stop surface 130, and the axial protrusion 115 is intended to engage through the through-hole 131.

Advantageously, in the preferred example embodiment of the invention, the stop member 13 has a concavity 132 facing the switch 12, arranged so that the stop member 13 bears on the frame 120 of the switch 12 via a peripheral zone extending at the periphery of said stop member 13. This feature makes it possible, on the one hand, to increase the resistance of the stop member 13 to mechanical stresses, said stresses being directed towards its periphery, and on the other hand, to transmit the stresses generated by the operation of the push-button 11 to the frame 120 of the switch 12. In other words, the forces generated by a possible shock are not transferred to the resilient blade 121 and to the central terminal 122 and peripheral terminals 123.

In the example embodiment shown in FIG. 2, the stop member 13 is arranged directly or indirectly against the central terminal 122, so that the latter is inserted between the stop member 13 and the striker element 111 when the push-button 11 is operated by the user. In other words, the stop member 13 is arranged to the rear of the central terminal 122, against the latter, if the front of the switch 12 is considered to be facing the push-button 11. This arrangement provides a translational stop if excessive force is applied to the switch 12, and in particular to the resilient blade 121, preventing any deformation thereof.

It should be noted that in this example embodiment, as shown in FIG. 2, the stop member 13 is inserted between the central terminal 122 and the structure 21 of the horological movement.

More precisely, the stop member 13 comprises a base plate 133 arranged to bear against the structure 21 of the horological movement and from which extends a protrusion 134 resting in abutment, by a free end, against the central terminal 122.

In this example embodiment, the body of the striker element 111 has no axial protrusion 115. In fact, as shown in FIG. 2, the body of the striker element 111 has only a flat bearing surface intended to apply a force against the switch 12, and more precisely, against the resilient blade 121.

This example embodiment is compatible with the embodiment of the damper 116 wherein it is inserted between the structure 21 of the horological movement and the switch 12, in the continuation of the direction A-A. In this case, the base plate 133 is arranged to bear against the damper 116. The invention is described in the context of an application of the invention to an electronic device formed by a watch. However, it goes without saying that the invention is not limited to this application and that it could advantageously be used with any other portable or non-portable electronic device.

More generally, it should be noted that the implementations and embodiments considered above have been described by way of non-limiting examples, and that other alternatives are consequently possible.

1. A control module (10) for an electronic device, comprising:
a push-button (11) including a striker element (111);
a switch (12) adapted to occupy a connected state and a rest state, said striker element (111) being configured to drive the switch (12) into the connected state or into the rest state when the push-button (11) is operated; and
a stop member (13) against which the striker element (111) comes to bear when it drives the switch (12) into the connected state or into the rest state.

2. The control module (10) according to claim 1, wherein the striker element (111) is provided with an axial protrusion (115) extending from a bearing surface with which it forms a shoulder, the striker element (111) being configured so that when it drives the switch (12) into the connected state or into the rest state, the axial protrusion (115) applies pressure to the switch and the bearing surface rests in abutment against the stop member (13).

3. The control module (10) according to claim 2, wherein the stop member (13) takes the form of a wall attached to the switch (12) and comprising a through-hole intended to receive the axial protrusion (115) of the push-button (11) when the striker element (111) drives the switch (12) into the connected state or into the rest state.

4. The control module (10) according to claim 3, wherein the switch (12) comprises a frame (120), the stop member (13) having a concavity arranged facing the switch (112) so that it bears on said frame (120) by a peripheral zone extending at the periphery of the stop member (13).

5. The control module (10) according to claim 1, further comprising a damper (116) configured to absorb part of the forces at play by deforming when the striker element (111) drives the switch (12) into the connected state or into the rest state, at least when said forces are greater than a predetermined threshold.

6. The control module (10) according to claim 5, wherein the damper (116) is arranged on the bearing surface of the striker element (111) so as to be compressed when the striker element (111) drives the switch (12) into the connected state or into the rest state.

7. The control module (10) according to claim 5, wherein the striker element (111) is provided with an axial protrusion (115) extending from a bearing surface with which it forms a shoulder, the striker element (111) being configured so that when it drives the switch (12) into the connected state or into the rest state, the axial protrusion (115) applies pressure to the switch and the bearing surface rests in abutment against the stop member (13), the damper (116) taking the form of a washer made of an elastically deformable material arranged around the axial protrusion (115).

8. The control module (10) according to claim 5, wherein the damper (116) is arranged between a structure (21) of the horological movement and the switch (12), in the continuation of the direction of travel of the push-button (11).

9. The control module (10) according to claim 1, wherein the switch (12) comprises a frame (120) to which a resilient blade (121) and connection terminals (122, 123) are attached, the resilient blade (121) being moved into a connecting position in which it generates contact between the connection terminals (122, 123), when the switch (12) is in the connection state, and being moved into a rest state in which it prevents any contact between the connection terminals (122, 123), when the switch is in the rest state, the stop member (13) being arranged in the continuation of the direction of travel of the push-button (11) against one of the connection terminals (122, 123) so that the latter is inserted between the stop member (13) and the striker element (111).

10. The control module (10) according to claim 9, wherein the striker element (111) comprises a body of substantially cylindrical shape having a radial dimension extending in a direction orthogonal to the direction of movement of the push-button (11), said radial dimension being smaller than the outside diameter of an end of the guide tube (113) at which it is arranged.

11. The control module (10) according to claim 1, wherein the push-button (11) comprises a push-button head (110) to which is connected a push-button rod (112) slidably engaged in a guide tube (113) and comprising a free end to which the striker element (111) is attached, the push-button (11) comprising a spring (114) inserted between the push-button head (110) and the guide tube (113) so as to force the push-button (11) to move towards a rest position.

12. A watch comprising a case in which an electronic horological movement is housed, the watch being comprising the control module (10) according to claim 1, the push-button (11) being engaged through a middle (20) with which the case is equipped, the switch (12) and the stop member (13) being attached to a structure (21) of the horological movement.
